(19) United States
(12) Patent Application Publication
(10) Pub. No.: US 2019/0032446 A1
(43) Pub. Date: Jan. 31, 2019

(54) BALL VALVE CAGE ASSEMBLY FOR RECIPROCATING DOWNHOLE PUMP

(71) Applicant: GLOBAL OIL AND GAS SUPPLIES INC., Beaumont, CA (US)

(72) Inventor: David Gronning, Beaumont (CA)

(21) Appl. No.: 16/041,481

(22) Filed: Jul. 20, 2018

Related U.S. Application Data
(60) Provisional application No. 62/535,561, filed on Jul. 21, 2017.

(51) Int. Cl. E21B 34/06; F16K 5/06

(52) U.S. Cl. CPC E21B 34/06; E21B 2034/002; F16K 5/0689

(57) ABSTRACT

A ball valve cage assembly and a method for assembling a ball valve cage for use in a downhole pump are provided. The cage assembly includes a cylindrical tubular shell, a cylindrical tubular insert, and an annular retainer. The shell includes an internal shoulder, and an internal threaded portion. The insert includes an internal ball stop. The retainer defines an external thread complementary to the internal threaded portion of the shell. The internal threaded portion, the insert, and the retainer are sized such that the retainer is disposed entirely within the shell when the insert is received in the shell, with a first end of the insert abutting the internal shoulder of the shell, an opposite second end of the insert abutting a first end of the retainer, and the external thread of the retainer and internal threaded portion of the shell in mating relationship.

### FIELD OF THE INVENTION

The present invention relates to ball valve cage assemblies for reciprocating downhole pumps, such as those used in oil producing wells.

### BACKGROUND

Pumpjacks used to extract oil from wells typically have a downhole pump that includes two ball valves: a stationary (or standing) valve at the bottom of the well tubing; and a travelling valve attached to the bottom end of a reciprocating plunger string. It is known for such ball valves to have a cage assembly that includes a cylindrical tubular shell, which receives a cylindrical tubular insert that comprises a ball stop. It is also known to retain the insert within the shell by friction welding the shell and insert together, or by screwing a bushing into the shell and into abutting relationship with the insert (see U.S. patent application publication number 2015/0075637 A1 (Gronning)).

### SUMMARY OF THE INVENTION

In one aspect, the present invention comprises a ball valve cage assembly for use in a downhole pump. The ball valve cage assembly comprises: a cylindrical tubular shell comprising an internal shoulder and an internal threaded portion; a cylindrical tubular insert comprising a first end, an opposite second end, and an internal ball stop; and an annular retainer defining an external thread complementary to the internal threaded portion of the shell. The internal threaded portion, the insert, and the retainer are sized such that the retainer is disposed entirely within the shell when the insert is received in the shell, with the first end of the insert in abutting relationship with the internal shoulder of the shell, and with the second end of the insert in abutting relationship with a first end of the retainer, and the external thread of the retainer and the internal threaded portion of the shell are in mating relationship.

In an embodiment of the ball valve cage assembly, when the retainer is disposed entirely within the shell, part of the internal threaded portion of the shell is unmated with the external thread of the retainer.

In embodiments of the ball valve cage assembly, each of the first end and the second end of the retainer comprises a flat annular surface.

In an embodiment of the ball valve cage assembly, the external thread of the retainer and the internal threaded portion of the shell are bonded together with a cured adhesive fluid. In an embodiment of the ball valve cage assembly, the second end of the insert and the first end of the retainer are bonded together with a cured adhesive fluid.

In another aspect, the present invention comprises a method of assembling a ball valve cage assembly for use in a downhole pump. The method comprises the steps of: (a) placing a cylindrical tubular insert into a cylindrical tubular shell, wherein the insert comprises a first end in abutting relationship with an internal shoulder of the shell, an opposite second end, and an internal ball stop; and (b) screwing an annular retainer into the shell to mate an external thread defined by the retainer with an internal threaded portion of the shell, such that a first end of the retainer is in abutting relationship with the second end of the insert, and the retainer is disposed entirely within the shell.

In an embodiment of the method, when the retainer is disposed entirely within the shell, part of the internal threaded portion of the shell is unmated with the external thread of the retainer.

In an embodiment of the method, the method further comprises the steps of: applying an adhesive fluid to one or both of the internal threaded portion of the shell and the external thread of the retainer, before the external thread of the retainer and the internal threaded portion of the shell are mated together; and allowing the adhesive fluid to cure and thereby bond the external thread of the retainer and the internal threaded portion of the shell, after the external thread of the retainer and the internal threaded portion of the shell are mated together. In an embodiment of the method, the method further comprises the steps of: applying an adhesive fluid to one or both of the second end of the insert, and the first end of the retainer, before the first end of the retainer is in abutting relationship with the second end of the insert; and allowing the adhesive fluid to cure and thereby bond the second end of the insert and the first end of the retainer, after the first end of the retainer is in abutting relationship with the second end of the insert.

### BRIEF DESCRIPTION OF THE DRAWINGS

In the drawings shown in the specification, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

FIG. 1 shows a disassembled side view of an embodiment of a travelling ball valve cage assembly (10) of the present invention.

FIG. 2 shows an assembled side view of the travelling ball valve cage assembly (10) of FIG. 1, with the insert (40) and the retainer (60) disposed inside the bore (22) of the shell (20).

FIG. 3 shows a perspective view of the retainer (60) shown in FIG. 1.

FIG. 4 shows a side, midline sectional view of another embodiment of a shell (20) similar to the embodiment of the shell (20) shown in FIG. 1.

FIG. 5 shows a disassembled perspective view of the shell (20) and retainer (60) of the embodiment of FIG. 4.

FIG. 6 shows a disassembled cross-sectional view of the embodiment of FIG. 4 with an insert.

FIG. 7 shows the embodiment of FIG. 6 in assembled form.

FIGS. 8A to 8C shows stages in the assembly of the embodiment of the standing ball valve cage assembly (10) of FIG. 4, with the use of a tool (80).

### DETAILED DESCRIPTION OF PREFERRED EMBODIMENT

Overview.

The ball valve cage assembly (10) of the present invention includes a cylindrical tubular shell (20), a cylindrical tubular insert (40), and an annular retainer (60). In an embodiment, the shell (20), insert (40), and retainer (60) may be made of a material suitable for use in a downhole environment such as a wear and corrosion resistant steel alloy. The insert (40) may be constructed of more wear-resistant material than the shell (20) since the insert (40) is subjected to greater wear from the movement of a ball within the insert (40).

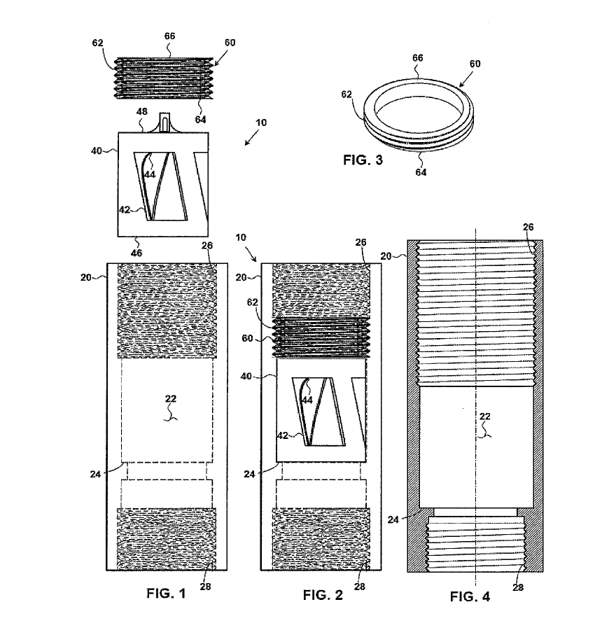

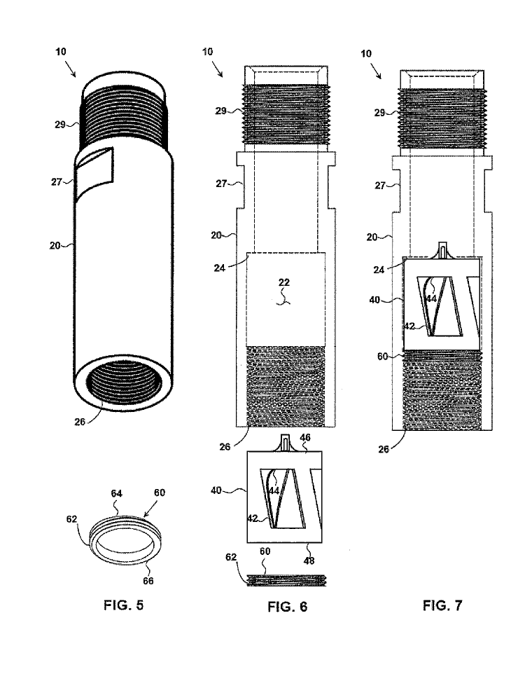

FIG. 1 shows a disassembled side view of an embodiment of a travelling ball valve cage assembly (10) of the present invention. FIG. 2 shows an assembled side view of the travelling ball valve cage assembly (10) of FIG. 1, with the insert (40) and the retainer (60) disposed inside the bore (22) of the shell (20). In FIGS. 1 and 2, internal features of the shell (20) and retainer (60) are shown in dashed lines. FIG. 3 shows a perspective view of the retainer (60) shown in FIG. 1. FIG. 4 shows a side, midline sectional view of another embodiment of a shell (20) similar to the embodiment of the shell (20) shown in FIG. 1.

FIG. 5 shows a disassembled perspective view of the shell (20) and retainer (60) of an embodiment of a standing ball valve cage assembly (10) of the present invention; the insert (40) has been omitted. FIG. 6 shows a disassembled side view of the shell (20), insert (40) and retainer (60) of the standing ball valve cage assembly (10) of FIG. 5. FIG. 7 shows an assembled side view of the standing ball valve cage assembly (10) of FIG. 5. In FIGS. 6 and 7, internal features of the shell (20) and the retainer (60) are shown in dashed lines.

Shell.

The cylindrical tubular shell (20) defines a bore (22) that receives the insert (40) and the retainer (60), and allows for flow of fluid through the shell (20).

The shell (20) comprises an internal shoulder (24) for limiting insertion of the insert (40) into the bore (22). In the embodiments shown in the Figures, the internal shoulder (24) is annular in shape. The surface of the internal shoulder (24) may face upwards (as shown in the embodiment of FIG. 1) or downwards (as shown in the embodiment of FIG. 6).

The shell (20) also comprises a first internal threaded portion (26), which is used to mate the shell (20) with the retainer (60). In the embodiments shown in the Figures, the first internal threaded portion (26) extends inwardly from a first open end of the shell (20). The first open end of the shell (20) may be at an upper end of the shell (20) (as shown in the embodiment of FIG. 1) or at a lower end of the shell (20) (as shown in the embodiment of FIG. 5).

The embodiment of the shell (20) shown in FIG. 1 comprises a second internal threaded portion (28) that extends inwardly from a second open end of the shell (20). The second internal threaded portion (28) may be used to mate the shell (20) with another externally threaded component of a downhole reciprocating pump, such as a travelling ball valve accessory.

The embodiment of the shell (20) shown in FIG. 5 comprises an external threaded portion (29) disposed near the second end of the shell (20). The external threaded portion (29) may be used to mate the shell (20) with another internally threaded component of a downhole reciprocating pump, such as the lower end of a pump barrel. The embodiment of the shell (20) shown in FIG. 5 also defines a pair of wrench flats (27) on the external surface of the shell (20) to receive gripping surfaces of a wrench, which may be used when screwing the retainer (60) into the shell (20) (as discussed below), or when screwing together the shell (20) and another threaded component of a downhole pump.

Insert.

The cylindrical tubular insert (40) is sized and shaped for insertion into the bore (22) of the shell (20). The insert (40) has a first end (46), an opposite second end (48), and an internal ball stop (44). In the embodiments shown in the FIGS. 6 and 7, the first end (46) of the insert (40) and the internal shoulder (24) of the shell (20) each have flat annular surfaces that may be abutted against each other. When a ball (not shown) is engaged with the ball stop (44), flow of fluid through the insert (40) is prevented. Alternatively, when the ball (not shown) is disengaged from ball stop (44), flow of fluid through the insert (40) is permitted. Such inserts (40) are known in the prior art, and the present invention is not limited by a particular configuration of insert (40). In the embodiment shown in the Figures, the insert (40) has a plurality of helically angled radial openings (42) and a semi-spherical internal ball stop (44), as described in U.S. Pat. No. 7,069,997 (Coyes et al.). Other embodiments of the ball valve cage assembly (10) of the present invention may have inserts (40) with different configurations, which may or may not have any radial openings (42).

Retainer.

The annular retainer (60) is sized and shaped for insertion into the bore (22) of the shell (20), and is used to retain the insert (40) therein. The retainer (60) defines an external thread (62) that is complementary to the internal threaded portion (26) of the shell (20). The retainer (60) has a first end (64) and an opposite second end (66). In the embodiments shown in the Figures, each of the first end (64) and the second end (66) of the retainer comprises a flat annular surface, having a significant area. For example, in the embodiment shown in FIG. 3, the annular surfaces have an outer diameter of about 1.75 inches, and an inner diameter of about 1.16 inches. For example, in the embodiment shown in FIG. 5, the annular surfaces have an outer diameter of about 1.5 inches, and an inner diameter of about 0.89 inches. In embodiments, the inner diameter may be in the range of about 50 percent to 75 percent of the outer diameter.

In the embodiments shown in the Figures, the flat annular surface at the first end (64) of the retainer (60) abuts against the flat annular surface of the second end (48) of the insert (40). In the embodiments shown in the Figures, the flat annular surface at the second end (66) of the retainer (60) may abut against another part of a downhole pump. For example, in the case of the travelling ball valve cage assembly (10) of FIG. 1, the second end (66) of the retainer (60) may abut against the lower end of a plunger rod (not shown). For example, in the case of the standing ball valve cage assembly (10) of FIG. 7, the second end (66) of the retainer (60) may abut against a seating assembly (not shown) at the bottom of an oil well.

Use and Operation.

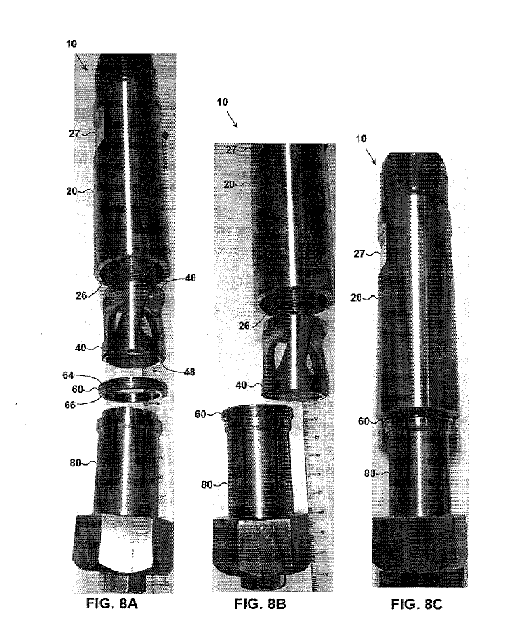

FIGS. 8A to 8C shows stages in the assembly of the embodiment of the standing ball valve cage assembly (10) of FIG. 4, with the use of a tool (80).

FIG. 8A shows the standing ball valve cage assembly (10) when disassembled, along with tool (80). The tool (80) has a first end that is adapted to grip the retainer (60), and a second end with a hex nut. Optionally, to better secure the insert (40) when the ball valve cage assembly (10) is assembled, an adhesive fluid (e.g., an epoxy adhesive, such as adhesives commonly referred to as “liquid weld” or “thread-locking fluid”) may be applied to any one or more of the internal shoulder (24) and the internal threaded portion (26) of the shell (20), the first end (46) and the second end (48) of the insert (40), and the external thread (62) and the first end (64) of the retainer (60). To assemble the ball valve cage assembly (10), the first end of the tool (80) is engaged with the retainer (60) (FIG. 8B). The insert (40) is inserted into the bore (22) of the shell (20), with a first end (46) of the insert (40) in abutting relationship with the internal shoulder (24) of the shell (20). The tool (80) is then used to screw the retainer (60) into the bore (22) of the shell (20) to mate the external thread (62) of the retainer (60) with the internal threaded portion (26) of the shell (20), so that the first end (64) of the retainer (60) is in abutting relationship with the second end (48) of the insert (40). The wrench flats (27) of the shell (20) and the nut of the tool (80) allow for use of wrenches that grip the shell (20) and the tool (80), respectively, to apply torque to these parts. Movement of the insert (40) relative to the shell (20) is limited by abutting relationship of the insert (40) with both the internal shoulder (24) and the first end (64) of the retainer (60). If adhesive fluid has been applied, the adhesive fluid is allowed to cure and thereby bond the mating external thread (62) retainer (60) to internal threaded portion (26) of the shell (20), and/or the abutting first end (46) of the insert (40) to the internal shoulder (24) of the shell (20), and/or the abutting second end (48) of the insert (40) to the first end (64) of the retainer (60).

The internal threaded portion (26), the insert (40), and the retainer (60) are sized so that the retainer (60) is disposed entirely within the shell (20), when the first end (64) of the retainer (60) is in abutting relationship with the second end (48) of the insert (40). In the embodiments shown in FIGS. 2 and 7, part of the internal threaded portion (26) of the shell (20) remains unmated with the external thread (62) of the retainer (60). Accordingly, the unmated part of the internal threaded portion (26) of the shell (20) may be used to mate the shell (20) with another externally threaded component of the downhole pump. As an example, the unmated part of the internal threaded portion (26) of the travelling ball valve cage assembly (10) of FIG. 2 may be used to mate with an externally threaded lower end of a plunger rod string (not shown). As another example, the unmated part of the internal threaded portion (26) of the standing ball valve cage assembly (10) of FIG. 7 may be used to mate with an externally threaded portion of a seating assembly (not shown) at the bottom of an oil well. As the retainer (60) and such other component of the downhole pump are separate parts, the shell (20) can be separated from such other part without being separated from the retainer (60), which continues to retain the insert (40) in the shell (20). At the same time, the use of a common internal threaded portion (26) to connect the shell (20) to both the other part and the insert (40) simplifies the construction of the ball valve cage assembly (10) and the downhole pump as a whole.

### Definitions and Interpretation

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of +5%, +10%, ±20%, or +25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A ball valve cage assembly for use in a downhole pump, the cage assembly comprising:
(a) a cylindrical tubular shell comprising an internal shoulder and an internal threaded portion;
(b) a cylindrical tubular insert comprising a first end, an opposite second end, and an internal ball stop; and
(c) an annular retainer defining an external thread complementary to the internal threaded portion of the shell;
wherein the internal threaded portion, the insert, and the retainer are sized such that the retainer is disposed entirely within the shell when the insert is received in the shell, with the first end of the insert in abutting relationship with the internal shoulder of the shell, and with the second end of the insert in abutting relationship with a first end of the retainer, and the external thread of the retainer and internal threaded portion of the shell are in mating relationship.

2. The ball valve cage assembly of claim 1, wherein when the retainer is disposed entirely within the shell, part of the internal threaded portion of the shell is unmated with the external thread of the retainer.

3. The ball valve cage assembly of claim 1, wherein the first end of the retainer comprises a flat annular surface.

4. The ball valve cage assembly of claim 1, wherein the second end of the retainer comprises a flat annular surface.

5. The ball valve cage assembly of claim 1, wherein the external thread of the retainer and the internal threaded portion of the shell are bonded together with a cured adhesive fluid.

6. The ball valve cage assembly of claim 1, wherein the second end of the insert and the first end of the retainer are bonded together with a cured adhesive fluid.

7. A method of assembling a ball valve cage for use in a downhole pump, the method comprising the steps of:
(a) placing a cylindrical tubular insert into a cylindrical tubular shell, wherein the insert comprises a first end in abutting relationship with an internal shoulder of the shell, an opposite second end, and an internal ball stop; and
(b) screwing an annular retainer into the shell to mate an external thread defined by the retainer with an internal threaded portion of the shell, such that a first end of the retainer is in abutting relationship with the second end of the insert, and the retainer is disposed entirely within the shell.

8. The method of claim 7, wherein when the retainer is disposed entirely within the shell, part of the internal threaded portion of the shell is unmated with the external thread of the retainer.

9. The method of claim 7, further comprising the steps of:
(a) applying an adhesive fluid to one or both of the internal threaded portion of the shell and the external thread of the retainer, before the external thread of the retainer and the internal threaded portion of the shell are mated together; and
(b) allowing the adhesive fluid to cure and thereby bond the external thread of the retainer and the internal threaded portion of the shell, after the external thread of the retainer and the internal threaded portion of the shell are mated together.

10. The method of claim 7, further comprising the steps of:
(a) applying an adhesive fluid to one or both of the second end of the insert, and the first end of the retainer, before the first end of the retainer is in abutting relationship with the second end of the insert; and
(b) allowing the adhesive fluid to cure and thereby bond the second end of the insert and the first end of the retainer, after the first end of the retainer is in abutting relationship with the second end of the insert.
